(19) United States
(12) Patent Application Publication
(10) Pub. No.: US 2017/0207588 A1
(43) Pub. Date: Jul. 20, 2017

(54) MICRO COAXIAL RADIO FREQUENCY CONNECTOR

(71) Applicant: Chia-Yen Yeh, Hsinchu City (TW)

(72) Inventor: Chia-Yen Yeh, Hsinchu City (TW)

(21) Appl. No.: 15/289,979

(22) Filed: Oct. 11, 2016

(30) Foreign Application Priority Data
Jan. 15, 2016 (TW) 105200610

(51) Int. Cl. H01R 24/40; H01R 9/05

(52) U.S. Cl. CPC H01R 24/40; H01R 9/0503; H01R 2103/00

(57) ABSTRACT

A micro coaxial RF connector applied to an audio processing unit includes a male connector with a connecting portion at an end, and the connecting portion has plural first screw threads, and the other end of the male connector is a transmission line, and a female connector is installed at a playing end of the audio processing unit, and the female connector has a groove, and plural second screw threads formed on the inner surface of the groove, configured to be corresponsive to the first screw threads, and electrically connected to the male connector. With the aforementioned locking and connecting method, the connector after many times of plugging and unplugging will not be loosened or damaged so easily, compared with the conventional insertion and flipping method, and the connector still maintains its original tightness after a long time of use, so as to maintain a stable sound quality.

### CROSS-REFERENCE TO RELATED APPLICATIONS

This non-provisional application claims priority under 35 U.S.C. §119(a) on Patent Application No(s). 105200610 filed in Taiwan, R.O.C. on Jan. 15, 2016, the entire contents of which are hereby incorporated by reference.

### FIELD OF THE INVENTION

The present invention relates to the field of a connector of an audio processing unit, and more particularly to a micro coaxial radio frequency (RF) connector locked by screws to overcome the issue of loosening the connector after a long time of use.

### BACKGROUND OF THE INVENTION

1. Description of the Related Art

At present, there are various types of device for processing and playing audio signals, and the common ones include a stereo device, an earphone, or a speaker, etc, and most of these devices are electrically connected to an audio signal source through a wire to achieve a playing effect. The earphone is the commonest one among these audio processing units, so that the earphone structure is used as an example for the illustration.

In the structure of a general earphone, a cavity and a wire is fixed and connected directly, so that if the wire is damaged, the earphone will not work anymore, and it is necessary to replace the whole earphone. However, the cost of the cavity is usually higher than the cost of wire, and it is a waste to throw away the cavity when just the wire is damaged. Therefore, related manufacturers have introduced a micro coaxial RF connector (MMCX) method for the cavity and wire which are detachable from one another to overcome the drawback of throwing away both cavity and wire when one of them is damaged. However, the general MMCX connectors are connected by an insertion and flipping method. In other words, the male connector has a fastener for fastening an engaging portion of the female connector after the female connector is plugged to prevent the male connector from being pulled out easily from the female connector. However, the earphone connected by this method may be loosened or damaged at the position where male connector and the female connector are connected after many times of plugging and unplugging. As a result, the contact becomes poor, the connectors cannot maintain their original tightness, the sound quality drops, and users cannot enjoy the sound quality of the same level anymore. These adverse effects also apply to other audio processing units such as the stereo and the speaker (which adopt the insertion and flipping method to connect the MMCX connector and the wire for transmitting audio signals), so that the aforementioned drawbacks still exist.

In view of the aforementioned drawbacks of the prior art, the inventor of the present invention based on years of experience in the related industry to conduct extensive researches and experiments, and finally designed and developed a micro coaxial RF connector with another connecting method to overcome the drawbacks of the prior art.

2. Summary of the Invention

Therefore, it is a primary objective of the present invention to improve over the prior art by providing a micro coaxial RF connector that uses a novel method to connect the connector, so as to overcome the drawback of the conventional connectors that may be loosened or damaged after long time of use.

To achieve the aforementioned and other objectives, the present invention discloses a micro coaxial RF connector, applied to an audio processing unit, and the micro coaxial RF connector comprises: a male connector, having a connecting portion disposed at an end thereof, a plurality of first screw threads formed on the connecting portion, and a transmission line disposed at the other end of the male connector; and a female connector, installed at the audio processing unit, and having a groove, and a plurality of second screw threads formed on an inner surface of the groove, configured to be corresponsive to the first screw threads respectively, and electrically coupled to the male connector.

Wherein, the connecting portion has a plurality of arc lugs symmetrically arranged with respect to one another and not in contact with one another. Preferably, the arc lugs come with a quantity of an even number, so that the arc lugs will not be tilted or stuck when the connecting portion is rotated into the groove.

In addition, the male connector has a plurality of through holes formed around the connecting portion and provided for discharging the air in the groove to the outside to prevent affecting the effect of locking the male connector and the female connector together.

The present invention further discloses an earphone with the aforementioned micro coaxial RF connector for transmitting audio signals, so as to prevent affecting the transmission of the audio signals or damaging the connecting portion after many times of plugging and unplugging.

The present invention further discloses an earphone with the aforementioned micro coaxial RF connector for transmitting audio signals, so as to affecting the transmission of the audio signals or damaging the connecting portion after many times of plugging and unplugging.

The present invention further discloses a computer host system with the aforementioned micro coaxial RF connector for transmitting audio signals, so as to affecting the transmission of the audio signals or damaging the connecting portion after many times of plugging and unplugging.

The present invention further discloses a display device with the aforementioned micro coaxial RF connector for transmitting audio signals, so as to affecting the transmission of the audio signals or damaging the connecting portion after many times of plugging and unplugging.

The present invention further discloses a mobile phone with the aforementioned micro coaxial RF connector for transmitting audio signals, so as to affecting the transmission of the audio signals or damaging the connecting portion after many times of plugging and unplugging.

The present invention further discloses a flat PC with the aforementioned micro coaxial RF connector for transmitting audio signals, so as to affecting the transmission of the audio signals or damaging the connecting portion after many times of plugging and unplugging.

With the aforementioned locking and connecting method, the connector after many times of plugging and unplugging will not be loosened or damaged so easily, compared with the conventional insertion and flipping method, and the connector still maintains its original tightness after a long time of use, so as to maintain a stable sound quality.

### BRIEF DESCRIPTION OF THE DRAWINGS

FIG. 1 is an exploded view of a first preferred embodiment of the present invention;

FIG. 2 is a first schematic view of the first preferred embodiment of the present invention after installation;

FIG. 3 is a second schematic view of the first preferred embodiment of the present invention after installation;

FIG. 4 is a third schematic view of the first preferred embodiment of the present invention after installation;

FIG. 5 is a fourth schematic view of the first preferred embodiment of the present invention after installation;

FIG. 6 is a fifth schematic view of the first preferred embodiment of the present invention after installation;

FIG. 7 is a sixth schematic view of the first preferred embodiment of the present invention after installation;

FIG. 8 is an exploded view of a second preferred embodiment of the present invention;

FIG. 9 is an exploded view of a third preferred embodiment of the present invention after installation; and

FIG. 10 is an exploded view of a fourth preferred embodiment of the present invention.

### DESCRIPTION OF THE PREFERRED EMBODIMENTS

The above and other objects, features and advantages of this disclosure will become apparent from the following detailed description taken with the accompanying drawings.

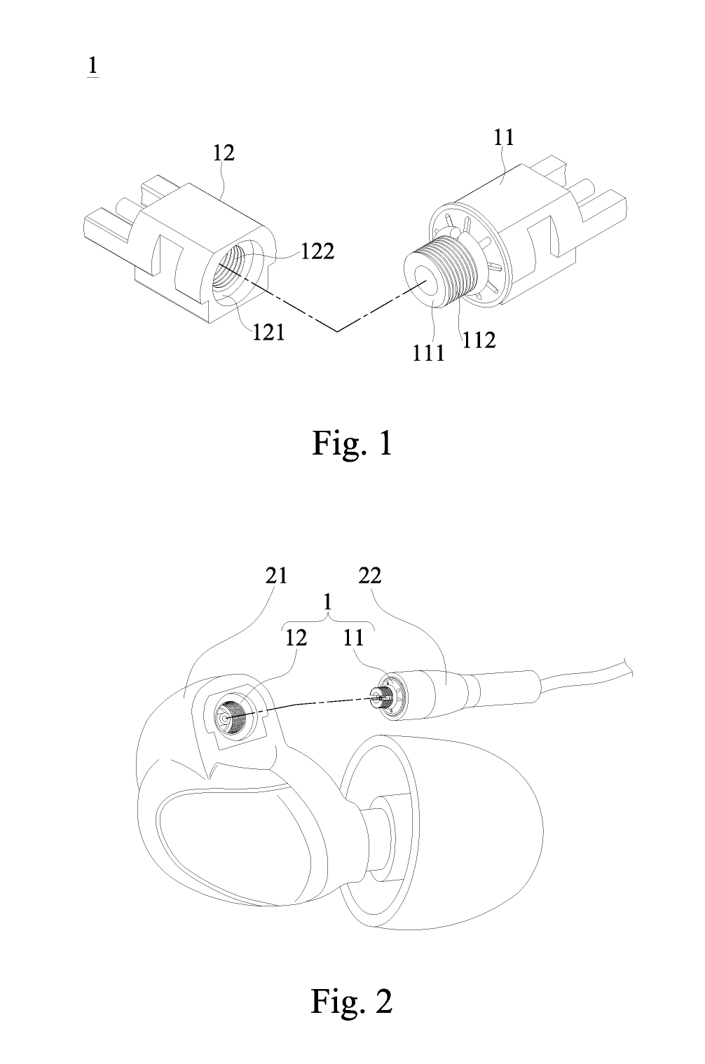

With reference to FIGS. 1 and 2 for an exploded view of a micro coaxial RF connector in accordance with the first preferred embodiment of the present invention and a first schematic view of the micro coaxial RF connector of the first preferred embodiment of the present invention after installation respectively, the micro coaxial RF connector 1 is applied to an audio processing unit 21, wherein the audio processing unit 21 generally refers to an object or unit capable of processing, transmitting, or playing audio signals, such as a built-in speaker of a television, a speaker of an earphone cavity, or an audio signal processor of a computer, but not just refers to the overall design a playing object such as an earphone, a stereo, etc. The micro coaxial RF connector 1 comprises a male connector 11, having a connecting portion 111 at its end, and a plurality of first screw threads 112 formed on the connecting portion 111, and a transmission line 22 disposed at the other end of the male connector 11; and a female connector 12, installed to the audio processing unit 21, and having a groove 121, a plurality of second screw threads 122 formed on an inner surface of the groove 121, configured to be corresponsive to the first screw threads 112, and electrically coupled to the male connector 11 for facilitating the transmission of audio signals and data.

With a screw connecting method, users may connect the male connector 11 and the female connector 12 together easily. Compared with the conventional insertion and flipping design, the invention maintains a tight connection between the male connector 11 and the female connector 12 after many times of plugging and unplugging and keeps a good sound quality. Since the first screw threads 112 and the second screw threads 122 are distributed on the connecting portion 111 and in the groove 121, therefore the present invention provides better engagement and connection than the conventional insertion and flipping method (that just uses a fastening member for the connection) and the invention can prevent the connector from being loosened or damaged effectively. An end opposite to the end of the female connector 12 having the groove 121 is electrically coupled to the audio processing unit 21. In the audio processing unit 21 of FIG. 2, a cavity of the earphone is used as an example for illustration, and the earphone adopts the method of the present invention to install the micro coaxial RF connector 1, so that users can enjoy the same sound quality no mater after how many times of connecting or detaching the cavity of the earphone and the transmission line 22, so as to prevent affecting the sound quality or incurring additional cost to buy a new earphone.

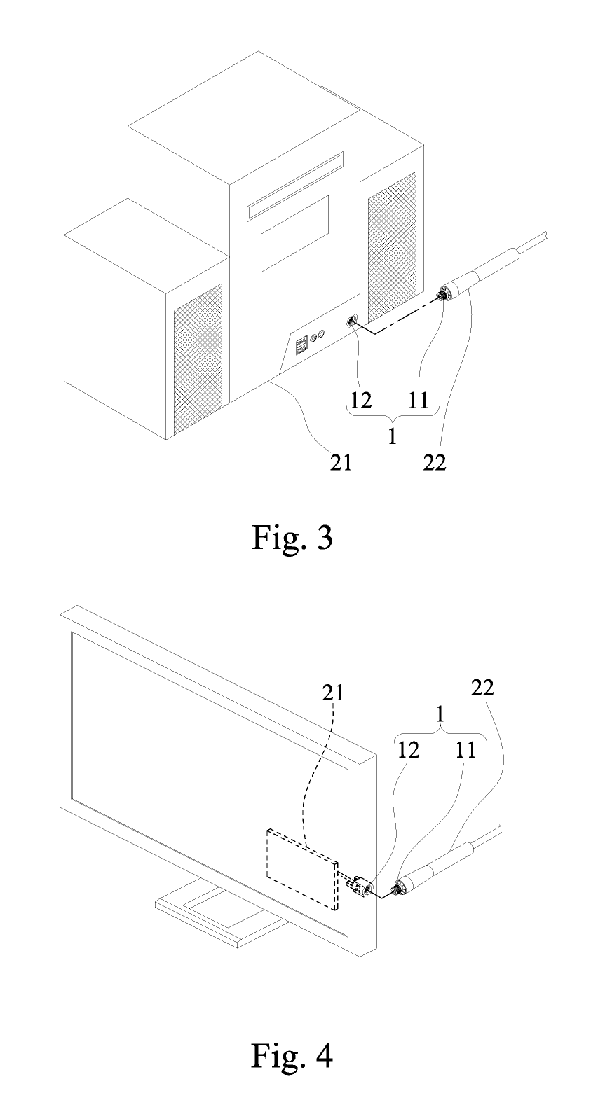

With reference to FIGS. 3 to 7 for a micro coaxial RF connector in accordance with the second to sixth preferred embodiment of the present invention after installation respectively, the micro coaxial RF connector 1 may be installed to various different electronic devices capable of playing audio signals, and the micro coaxial RF connector 1 and the audio processing unit 21 are electrically coupled to each other, and the audio signal is transmitted to the electronic device for the playback or transmitted from the electronic device to another place for the playback. In FIG. 3, the present invention provides a stereo having the female connector 12 installed at an end of the stereo, wherein the audio processing unit 21 is a stereo for processing, outputting, or receiving the audio signal, and the audio processing unit 21 is electrically coupled to the female connector 12, and the female connector is coupled to the male connector 11 which is coupled to the transmission line 22, so that the micro coaxial RF connector 1 may transmit the audio signal to the stereo end for the playback. Similarly, the micro coaxial RF connector 1 is connected by a screw connecting method, so that the invention can prevent affecting the transmission of audio signals or damaging the connecting portion after many times of plugging and unplugging the connector.

In FIG. 4, the present invention provides a display device, and the audio processing unit 21 refers to a signal processing module or a processor installed in the display device for processing an audio signal outputted from the display device, and the female connector 12 is embedded into a casing of the display device and has an end electrically coupled to the audio processing unit 21 and the other end coupled to the male connector 11 which is coupled to the transmission line 22. Through the micro coaxial RF connector 1, the audio signal of the audio processing unit 21 is transmitted to the outside and then played by a playing device such as an earphone or a stereo, etc. Similarly, the micro coaxial RF connector 1 is connected by a screw connecting method, so that the invention can prevent affecting the transmission of audio signals or damaging the connecting portion after many times of plugging and unplugging the connector.

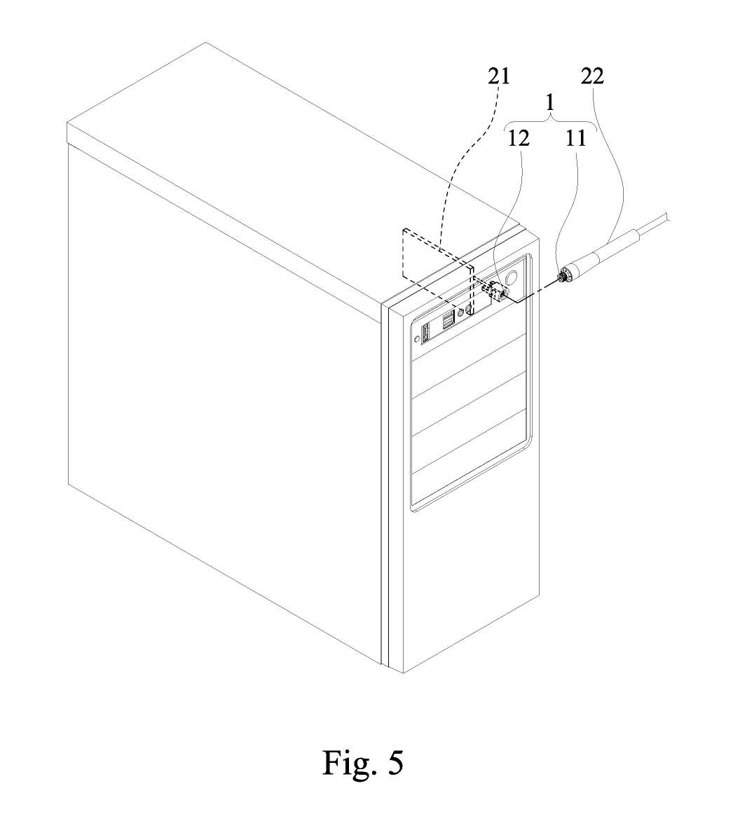

In FIG. 5, the present invention provides a computer host system, and the audio processing unit 21 refers to a signal processing module or a processor installed in the computer host system for processing an audio signal outputted from the display device, and the female connector 12 is embedded into a casing of the computer host system and has an end electrically coupled to the audio processing unit 21 and the other end coupled to the male connector 11 which is coupled to the transmission line 22. Through the micro coaxial RF connector 1, the audio signal of the audio processing unit 21 is transmitted to the outside and then played by a playing device such as an earphone or a stereo, etc. Similarly, the micro coaxial RF connector 1 is connected by a screw connecting method, so that the invention can prevent affecting the transmission of audio signals or damaging the connecting portion after many times of plugging and unplugging the connector.

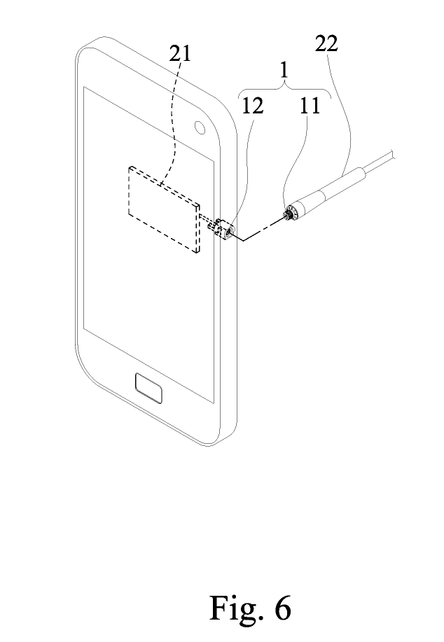

In FIG. 6, the present invention provides a mobile phone, and the audio processing unit 21 refers to a signal processing module or a processor installed in the mobile phone for processing an audio signal outputted from the display device, and the female connector 12 is embedded into a casing of the mobile phone and has an end electrically coupled to the audio processing unit 21 and the other end coupled to the male connector 11 which is coupled to the transmission line 22. Through the micro coaxial RF connector 1, the audio signal of the audio processing unit 21 is transmitted to the outside and then played by a playing device such as an earphone or a stereo, etc. Similarly, the micro coaxial RF connector 1 is connected by a screw connecting method, so that the invention can prevent affecting the transmission of audio signals or damaging the connecting portion after many times of plugging and unplugging the connector.

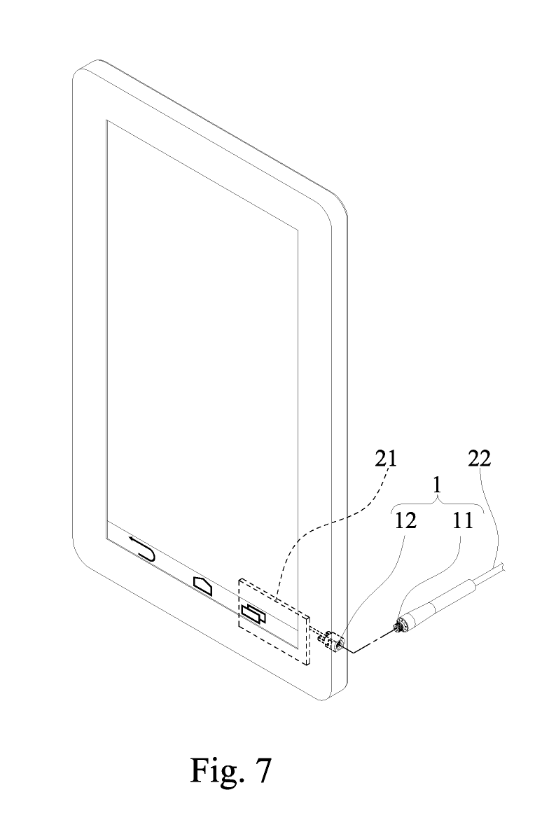

In FIG. 7, the present invention provides a flat PC, and the audio processing unit 21 refers to a signal processing module or a processor installed in the flat PC for processing an audio signal outputted from the display device, and the female connector 12 is embedded into a casing of the flat PC and has an end electrically coupled to the audio processing unit 21 and the other end coupled to the male connector 11 which is coupled to the transmission line 22. Through the micro coaxial RF connector 1, the audio signal of the audio processing unit 21 is transmitted to the outside and then played by a playing device such as an earphone or a stereo, etc. Similarly, the micro coaxial RF connector 1 is connected by a screw connecting method, so that the invention can prevent affecting the transmission of audio signals or damaging the connecting portion after many times of plugging and unplugging the connector.

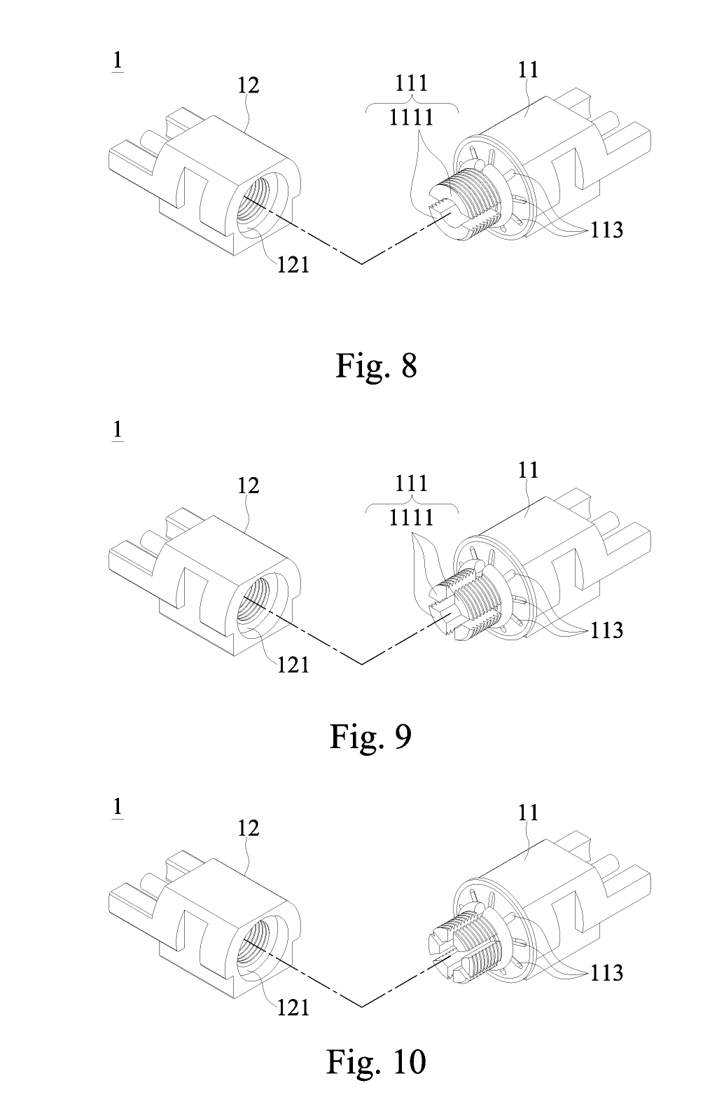

With reference to FIGS. 8 to 10 for the exploded views of the second, third and fourth preferred embodiments of the present invention respectively, these embodiments are substantially the same as the first preferred embodiment except that the connecting portion 111 of these embodiments further has a plurality of arc lugs 1111 symmetrically arranged and not in contact with one another. Preferably, the quantity of the arc lugs 1111 is an even number, so that the arc lugs 1111 will not be tilted or stuck easily when the connecting portion 111 is rotated into the groove 121. In the second preferred embodiment, there are two arc lugs 1111, and a straight-line shaped space is formed between the arc lugs 1111 to prevent tilting or jamming when the connecting portion 111 is rotated into the groove 121 and provide an aligning effect. In the third preferred embodiment, a cross-shaped space is formed between the arc lugs 1111. In the fourth preferred embodiment, an “*” shaped space is formed between the arc lugs 1111. With the aforementioned different spaces formed and included between the arc lugs 1111, the male connector 11 and the female connector 12 may be engaged more easily during the connection, so as to improve the convenience of the screw connection.

In addition, the male connector 11 has a plurality of through holes 113 formed around the connecting portion 111 and provided for discharging air in the groove 121 to the outside to prevent hindering the connection of the male connector 11 and the female connector 12, so as to improve the locking effect.

In summation of the description above, the present invention can prevent the connector from being loosened or damaged easily after many times of plugging or unplugging the connector and maintains the original tightness of the connector after a long time of use, and the micro coaxial RF connector 1 is applicable to various different electronic device for transmitting audio signals for playback.

What is claimed is:

1. A micro coaxial RF connector, applied to an audio processing unit, comprising:
a male connector, having a connecting portion disposed at an end thereof, a plurality of first screw threads formed on the connecting portion, and a transmission line disposed at the other end of the male connector; and
a female connector, installed at the audio processing unit, and having a groove, and a plurality of second screw threads formed on an inner surface of the groove, configured to be corresponsive to the first screw threads respectively, and electrically coupled to the male connector.

2. The micro coaxial RF connector according to claim 1, wherein the connecting portion has a plurality of arc lugs symmetrically arranged with respect to one another and not in contact with one another.

3. The micro coaxial RF connector according to claim 2, wherein the arc lugs come with a quantity of even number.

4. The micro coaxial RF connector according to claim 3, wherein the male connector has a plurality of through holes formed around the connecting portion.

5. An earphone, having the micro coaxial RF connector according to claim 1, for transmitting an audio signal.

6. A stereo, having the micro coaxial RF connector according to claim 1, for transmitting an audio signal.

7. A display device, having the micro coaxial RF connector according to claim 1, for transmitting an audio signal.

8. A computer host system, having the micro coaxial RF connector according to claim 1, for transmitting an audio signal.

9. A mobile phone, having the micro coaxial RF connector according to claim 1, for transmitting an audio signal.

10. A flat PC, having the micro coaxial RF connector according to claim 1, for transmitting an audio signal.
